(19) United States
(12) Patent Application Publication
(10) Pub. No.: US 2007/0262188 A1
(43) Pub. Date: Nov. 15, 2007

(54) Tape reel, method of and apparatus for attaching tape to reel hub and method of and apparatus for winding tape on tape reel

(75) Inventor: Kazuo Kubota, Kanagawa (JP)

Correspondence Address: YOUNG & THOMPSON, 745 SOUTH 23RD STREET, 2ND FLOOR, ARLINGTON, VA, 22202, US

(73) Assignee: FUJIFILM CORPORATION, Tokyo (JP)

(21) Appl. No.: 11/797,705

(22) Filed: May 7, 2007

(30) Foreign Application Priority Data
May 9, 2006 (JP) 2006-129904

(51) Int. Cl. B65H 19/28; B65H 75/28; G11B 23/107

(52) U.S. Cl. 242/532.2; 242/348.1; 242/581

(57) ABSTRACT

A tape reel on which a tape strip is wound comprises a cylindrical reel hub having pores distributed allover a hub wall and a center bore formed axially therein and flanges connected opposite ends of the reel hub. The interior of the center bore of the reel hub is depressurized so as thereby to attach an end portion of a tape strip to the reel hub with air sucked in through the pores.

### BACKGROUND OF THE INVENTION

1. Field of the Invention

The present invention relates to a tape reel, a tape cartridge and a method of attaching a magnetic tape strip to a reel hub of the tape reel.

2. Description of Related Art

Typically, data storage magnetic tape cartridges are commonly used as an external memory device for computer data backup. Such a tape cartridge comprises a cartridge case, a tape reel and its associated parts enclosed in the cartridge case. Generally, the tape reel comprises a cylindrical core formed as a reel hub on which a tape strip is wound and upper and lower flanges radially extending at opposing ends of the reel hub. In a tape cartridge manufacturing line, tape winding is entered by firmly attaching one end of the magnetic tape strip to the reel hub using a tape end sticking apparatus There have been proposed a variety of tape end sticking apparatuses. One of the tape end sticking apparatuses which is known from, for example, Japanese Unexamined Patent Publication No. 2005-322353 comprises a tape carrier having a sponge pad instilled with a sticking liquid which is adapted to suck and grasp one tape end of a magnetic tape strip with vacuum and capable of moving in and out of a cartridge case. When the tape carrier is moved into the cartridge case, the tape carrier brings the sponge pad into contact with the reel hub so as to apply the sticking liquid to the reel hub and then, sticks the end portion of magnetic tape strip on the reel hub. Subsequently, while moving back the tape carrier out of the cartridge case, a desired length of the magnetic tape strip is wound on the reel hub and cut off.

A problem encountered by the tape end sticking apparatus is an occurrence of defects in tape end sticking due to excessively large or small spreads of sticking liquid. Specifically, an excessively large spread f sticking liquid causes the end portion of magnetic tape strip slips relatively to the reel hub and is stuck in an off-center position with respect to the reel hub consequently or fails to stick on the reel hub. In some cases, a redundant spread of sticking liquid runs off from between the tape end portion and the reel hub and is left as adhesion vestiges on flanges which are undesirable in appearance. On the other hand, an excessively small spread of sticking liquid fails in unsuccessful sticking of the tape end portion on the reel hub and, in particular, accounts for a turnup or a bend of the tape end portion.

### SUMMARY OF THE INVENTION

The present invention has been made with the intention to solve the aforesaid problems and has its object to provide a tape reel which enables to attach an end portion of tape strip to a reel hub thereof without using a sticking liquid.

The present invention has another object to provide a tape cartridge for enclosing a tape reel which enables to attach an end portion of tape strip to a reel hub thereof without using a sticking liquid.

The foregoing objects of the present invention is accomplished by a tape reel comprising a reel hub which has a center bore formed axially therein and pores for air intercommunication between the interior and the exterior of the center bore of the reel hub, a first flange connected to one of opposite ends of the reel hub, and a second flange connected to the other end of the reel hub in parallel with the first flange. It is preferred that the reel hub is made of a porous material.

According to the tape reel since the reel hub has pores for air intercommunication between the interior and the exterior of the center bore of the reel hub, it is realized to attach an end portion of tape strip to the reel hub without using a sticking liquid at the beginning of winding of the tape strip on the tape reel. Nonuse of sticking liquid eliminates an occurrence of defects in attaching a tape end to the tape reel and provides stable quality of tape end attaching to the reel hub and, since a product of porous material has intrinsic pores distributed uniformly allover the product, the reel hub is capable of making an end portion of tape strip to attach uniformly thereto. In consequence, the tape reel prevents an occurrence of a radial irregularity in a roll of tape strip wound on the reel hub.

The method of attaching an end portion of a tape strip to a reel hub of a tape reel which is provided with flanges connected to opposite ends of the reel hub before winding the tape strip on the tape reel, the reel hub having a center bore formed axially therein and pores for air communication between the interior and the exterior of the center bore, comprises the steps of setting the tape reel into a state where the tape reel is rotatable and the center bore of the reel hub is closed at axial ends thereof, grasping the end portion of the tape strip by a tape carrier movable in close proximity to and away from the tape reel, moving the tape carrier grasping the end portion of the tape strip until the end portion of the tape strip is placed adjacently to the reel hub, and depressurizing the center bore of the reel hub so as thereby to attach the end portion of tape strip to the reel hub with air sucked in through the pores.

According to the tape end attaching method, since an end portion of tape strip grasped by the tape carrier is attached to the reel hub without using a sticking liquid, no defect takes place in attaching a tape end to the tape reel and stable quality of tape end attaching is provided.

The tape cartridge is manufactured by winding a tape on the tape reel after attaching a tape end of the tape to the reel hub of the tape reel by the tape end attaching method. Accordingly, it is realized to provide a tape cartridge with a roll of tape wound on the tape reel superior in terms of winding quality.

### BRIEF DESCRIPTION OF THE DRAWINGS

The foregoing and other objects and features of the present invention will be clearly understood from the following detailed description when reading with reference to the accompanying drawings wherein same and similar parts or devices are denoted by the same reference numerals and in which:

FIG. 1 is an exploded schematic view of a tape reel according to an embodiment of the present invention;

FIG. 2 is an exploded schematic view of a tape reel according to alternative embodiment of the present invention;

FIG. 3 is an exploded perspective view of a magnetic tape cartridge according to an embodiment of the present invention;

FIG. 4 is a schematic view of a tape winder;

FIG. 5 is an exploded perspective view of a tape reel carrier of the tape winder;

FIG. 6A is a side view of the tape reel carrier, partly broken, with a tape reel mounted thereon;

FIG. 6B is a perspective sectional view of a rotary joint unit of the tape reel carrier;

FIG. 7 is a perspective view of a tape carrier;

FIGS. 8A through 8E are illustrations showing a tape end attaching process;

FIG. 9 is a side view of a variation of the tape reel carrier, partly broken, with a tape reel mounted thereon;

FIG. 10 is a top view of a face gear of the tape reel carrier shown in FIG. 9;

FIG. 11 is a sectional view of another variation of the tape reel carrier with a tape reel mounted thereon;

FIG. 12A is a perspective sectional view of a rotary joint unit of the tape reel carrier shown in FIG. 11; and

FIG. 12B is an exploded sectional view of the of a rotary joint unit of the tape reel carrier.

### DETAILED DESCRIPTION OF THE PREFERRED EMBODIMENTS

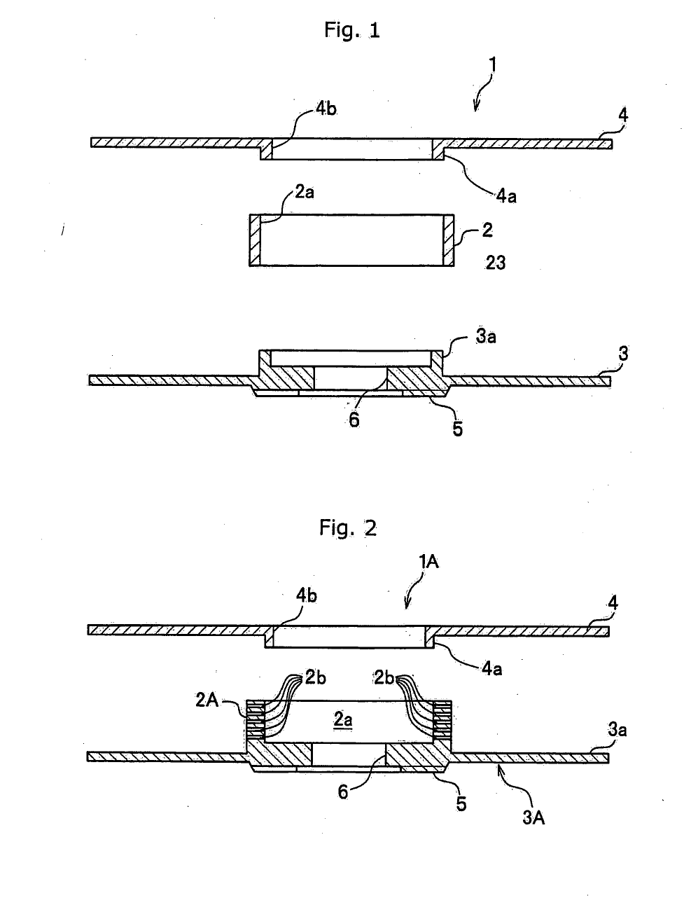

Referring now to the accompanying drawings in detail FIG. 1 is an exploded sectional view of a tape reel 1 according to an embodiment of the present invention. The tape reel 1 comprises a cylindrical reel hub 2 having a center bore 2a formed axially therein which is made of a porous material such as a porous metal, a porous resin or a porous ceramic material and upper or first and lower or second disk-shaped flanges 3 and 4 which are identical in outer diameter. The reel hub 2 has a number of pores distributed uniformly allover the hub wall which permit air to intercommunicate between the interior and the exterior of the center bore 2a of the reel hub 2. The lower flange 3 has a circular center opening 6 surrounded by a circular boss 3a which extends from the inner surface of the lower flange 3 so as to fit tightly in one of opposite axial end openings of the center bore 2a of the reel hub 2 and has an inner diameter sufficiently grater than the circular center opening 6 and is provided with a driven face gear 5 formed on an outer surface thereof so as to surround the center opening 6. The driven face gear 5 is adapted to engage with a diving face gear formed as a part of a spindle of a reel driving mechanism of a recording/reproducing apparatus. The upper flange 4, similar in shape to the upper flange 3, has a circular center opening 4b surrounded by a circular boss 4a which extends so as to fit in another axial end opening of the center bore 2a of the reel hub 2. The tape reel 1 is assembled by fitting the bosses 3a and 4a of the lower and upper flanges 3 and 4 in the opposite axial end openings of the center bore 2a of the reel hub 2.

The tape reel 1 may be made up of upper and lower flanges 4 and 3 produced by injection molding and the reel hub 2 formed by sinter casting a powder resin or a powder metal in a metal mold. These flanges 3 and 4 fitted to the reel hub 2 may be bonded to each other with an adhesive, or otherwise by ultrasonic bonding if all components are made of resins. Examples of the porous material for the reel hub 2 include a porous resin such as polytetrafluoro-ethylene having a pore size of from 1 to 100 μm and a porous metal prepared by sintering stainless steel particles having a particle size of 0.1 mm so as to have an open area ratio of 15%, a void ratio of 30% and a density of 6 g/cm³.

Referring to FIG. 2 showing a tape reel 1A according to another embodiment of the present invention, the tape reel 1A comprises an upper flange 4 just the same as that of the previous embodiment shown in FIG. 1 and a lower flange 3A in the form of an integral hub-flange component which consists of a reel hub portion 2A having a center bore 2a formed axially therein and a flange portion 3a. The lower flange portion 3a itself is identical in dimensions and shape with that of the previous embodiment shown in FIG. 1. However, the reel hub portion 2A, which is an integral part of the lower flange component 3A and has the same dimensions as that of the previous embodiment shown in FIG. 1, is provided with a number of pores 2b distributed at a desired bore density allover the hub wall which permit air to intercommunicate between the interior and the exterior of the center bore 2a of the reel hub 2. The tape reel 1A is assembled by fitting the boss 4a of the upper flange 4 in an axial end opening of the center bore 2a of the reel hub portion 2A and fixed to each other.

The upper flange 4 may be produced from a resin material by injection molding. On the other hand, the lower flange component 3A is prepared by forming a half-finished product having no pores 2b in the hub wall of the reel hub portion 2A by injection molding and, thereafter, forming the pores 2b in the reel hub portion 2A using, for example, a drilling machine. The tape reel 1A is completed by fitting the boss 4a of the upper flange 4 in an axial end opening of the center bore 2a of the reel hub portion 2A and bonding them with an adhesive, or otherwise by ultrasonic bonding if both components are made of resins.

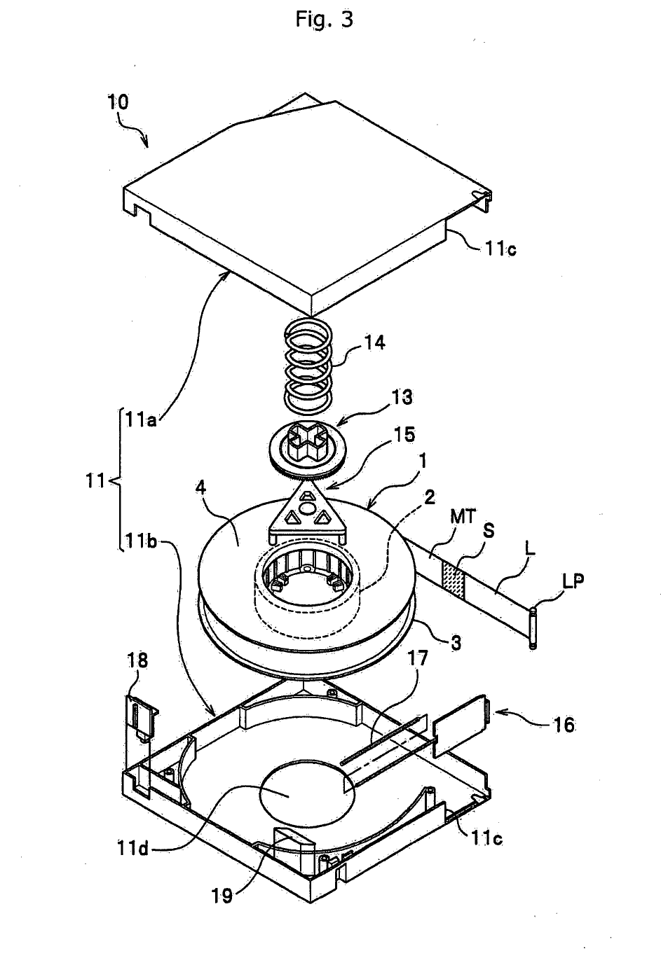

FIG. 3 shows a magnetic tape cartridge 10 according to an embodiment of the present invention which is of a type compliant to LTO (Linear Tape Open) standard. Hereafter, the magnetic tape cartridge 10 is described as provided with the tape reel 1 shown in FIG. 1 by way of example. Generally, the magnetic tape cartridge 10 comprises a cartridge case 11 made up of two mating shell halves 11a and 11b, a dustproof door 16 forced closed by a coil spring 17 to prevent dirt particles from entering the cartridge interior through a tape egress/ingress opening 11c located between the two shell halves 11a and 11b and slid open against the spring 17 to permit tape movement into and out of the cartridge interior via the tape egress/ingress opening 11c, a tape reel 1 rotatable inside the cartridge case 11 in opposite tape winding and tape unwinding directions to wind a magnetic tape strip MT on a cylindrical core as a reel hub 2 of a tape reel 1 and to unwind the magnetic tape strip MT off the reel hub 2, a reel lock 13 for preventing the tape reel 1 from rotating, a coil spring 14 for forcing the reel lock 13 against the reel hub 2, and a release pad 15 for unlocking the tape reel 1. The magnetic tape strip MT at its leading end is provided with a leader tape strip L connected by means of a splicing strip S and a leader pin LP attached to the free end of the leader tape strip L. The tape reel 1 has disk-shaped flanges 3 and 4 fixedly attached to opposite ends of the reel hub 2. The magnetic tape cartridge 10 is provided with a faulty erasure prevention claw 18 and an IC chip 19 installed therein. As was previously described, the reel hub 2 is made of a porous material and has a number of pores for air intercommunication between the inside and the outside of the center bore 2a.

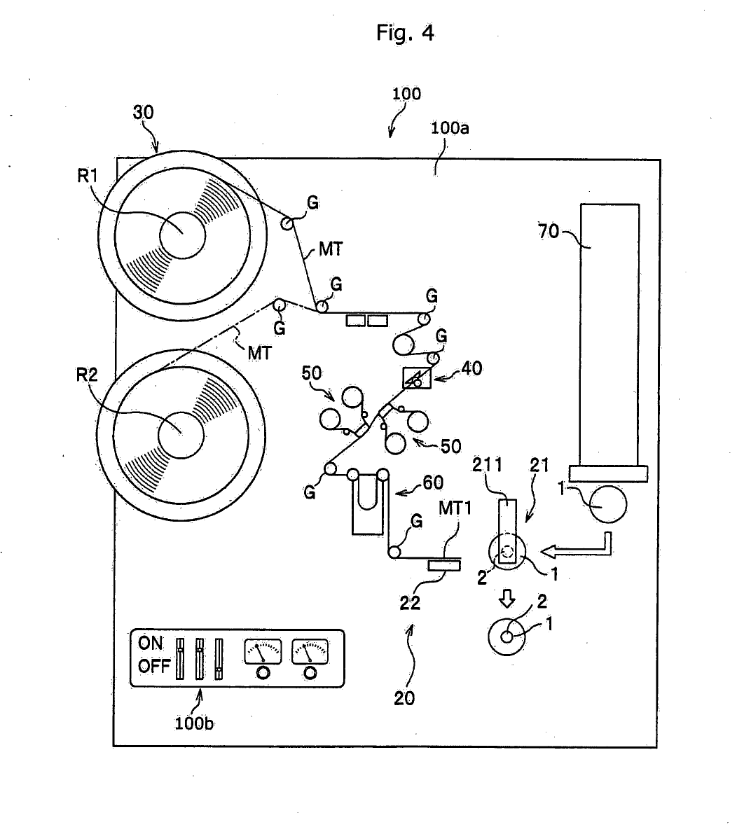

FIG. 4 shows a tape winding apparatus 100 for winding a magnetic tape strip MT on the reel hub 2 of the tape reel 1. The tape winding apparatus 100 winds magnetic tape strips MT which are prepared by cutting a magnetic tape stock rolled in the shape like a pancake into rolls having a given tape width and by cutting it into a given length. The tape winding apparatus 100 comprises a tape feeder 30 for feeding a magnetic tape strip MT to be wound on a tape reel 1, and a tape end attaching apparatus 20 for attaching a foremost end portion of magnetic tape strip MT to the reel hub 2 of the tape reel 1 which is fed from a stuck of a number of empty tape reels by a reel feeder 70. The tape winding apparatus 100 is further provided with a plurality of guide rollers G for defining a given traveling path of a magnetic tape strip MT between the tape feeder 30 and the tape end attaching apparatus 20, a polishing device 40 for polishing a coated surface of the magnetic tape strip MT, a pair of cleaning devices 50 for cleaning both surfaces of the magnetic tape strip MT and a tension control device 60 for controlling tension of the magnetic tape strip MT. An operation control panel 100b is installed to the panel 100a of the tape winding apparatus 100. These devices 40, 50, 60 and 70 are known in various forms and may take any forms known in the art, respectively.

The tape feeder 30 includes two tape reels R1 and R2, each reel R1, R2 having a roll of a roll of magnetic tape strip MT wound thereon, and drives it to feed the magnetic tape strip MT at a predetermined constant rate toward the tape end attaching apparatus 20. When one of the tape reels R1 and R2 runs out of the magnetic tape strip MT, the other tape reel R1 or R2 is alternatively driven to feed the magnetic tape strip MT toward the tape end attaching apparatus 20 so as thereby to feed the magnetic tape strip MT continuously. The tape end attaching apparatus 20 comprises a reel setting device 21 for receiving an empty tape reel 1 from the reel feeder 70 and setting the tape reel 1 for rotation at a high speed, a tape carrier 22 for sucking and grasping an end portion of magnetic tape strip MT fed from the tape feeder 30 and carrying it to the reel hub 2 of the tape reel 1 received in the reel setting device 21. The reel setting device 21, which is located near a lower right corner on the panel 100a, holds the tape reel 1 so as to permit the tape reel 1 to rotate.

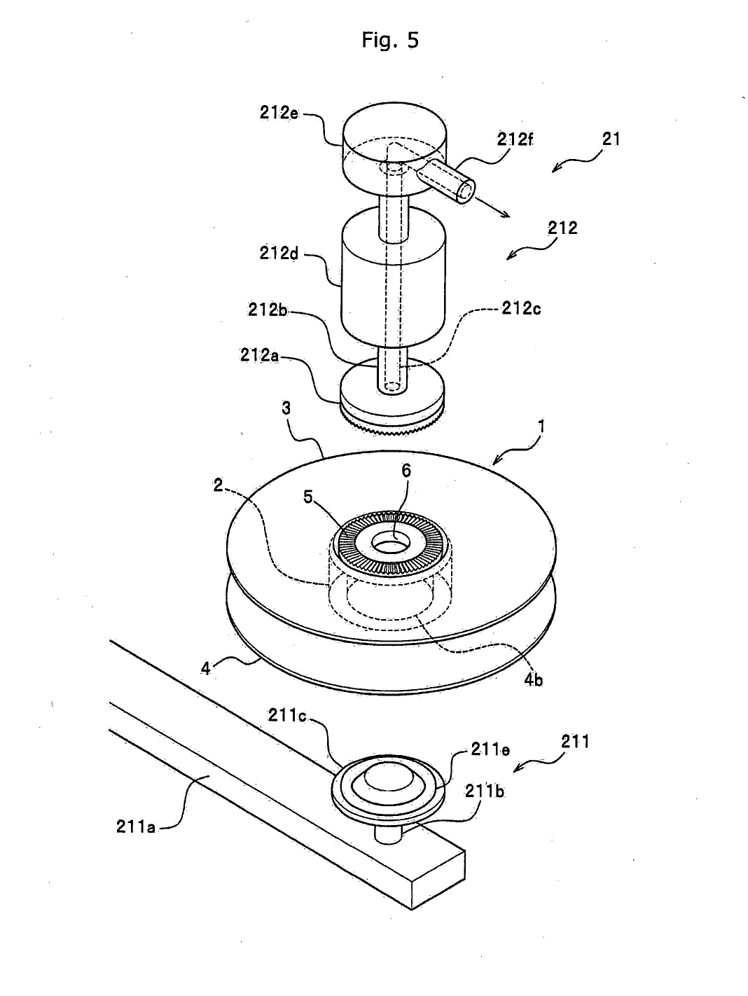

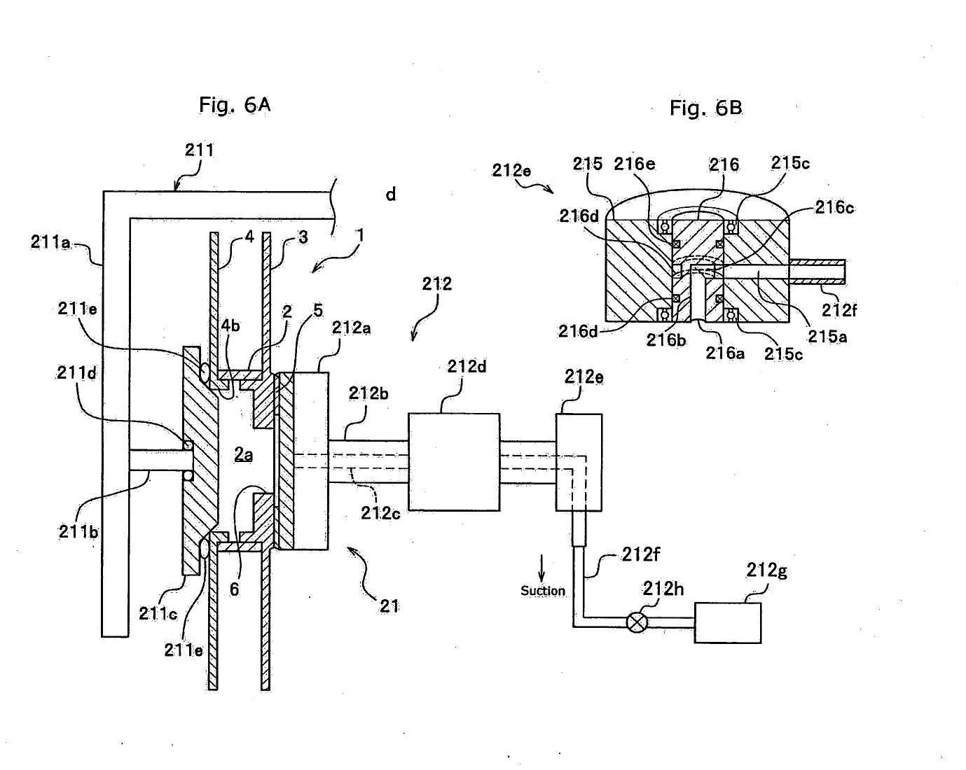

Referring to FIGS. 5, 6A and 6B showing the reel setting device 21 in detail, the tape reel setting device 21 comprises a tape reel driving device 211 for rotatably supporting the tape reel 1 from a side of the upper flange 4 and a reel driving unit 212 for driving the tape reel 1 from a side of the lower flange 3. Specifically, the tape reel driving device 211 comprises a reverse L-shaped base support 211a movable vertically along the panel 100a and horizontally in a direction perpendicular to the panel 100a, a positioning head 211c which has a tapered side wall engagable with the center opening 4b of the upper flange 4 of the tape reel 1 for positioning a front surface of the tape reel 1 and is connected to shaft 211b mounted on the base support 211a through a ball bearing 211d for rotation, a sealing ring 211e attached to the positioning head 211c. When the positioning head 211c engages with the center opening 4b of the upper flange 4 of the tape reel 1, the center bore 2a of the reel hub 2 is air-tightly closed at one axial end thereof. The reel driving unit 212 comprises a driving head 212a comprising a face gear (driving face gear) mounted to one of opposite ends of the rotary shaft 212b which is engageable with the driven face gear 5 of the lower flange 4 of the tape reel 1, a motor 212d provided with a rotary shaft 212b having an air passage 212c formed axially therein, a rotary joint unit 212e connected to the other end of the rotary shaft 212b and to a vacuum pump 212g through a suction pipe 212f having a valve 212h therein. When these face gears are engage with each other, the other axial end of the center bore 2a of the reel hub 2 is air-tightly closed. The air passage 212c extends throughout the rotary shaft 212b of the motor 212d and is air tightly connected to a center bore 2a formed as an extension of the air passage 212c in the driving face gear 212a which opens into the center bore 2a of the reel hub 2 when the tape reel 1 is supported on the tape reel driving device as shown in FIG. 6A.

As shown in FIG. 6B, the rotary joint unit 212e, which has a cylindrical shape, comprises a cylindrical hollow stator 215 and a rotor 216 held for rotation in the stator 215 at opposite ends by ball bearings 215c. The rotor 216 has an annular groove 216d formed in an outer wall thereof and an air passage 216a having an axial section 216b intercommunicating with the air passage 212c formed in the rotary shaft 212b of the motor 212d and a radial section 216c intercommunicating with the annular groove 216d. The stator 215 has a radial air passage 215a opening at one end to the annular groove 216d of the rotor 216 and connected at another end to the suction pipe 212f. Between the stator 215 and the rotor 216 there is provided sealing rings 216d disposed on opposite sides of the annular groove 216c so as to prevent air from escaping from the annular groove 216c. With this air passage arrangement, the suction pipe 212f is always kept communicated with the air passage 216a through the annular groove 216c despite of rotation of the rotor 216. The rotary joint unit 212e is known in various forms and takes any form well known in the art such as a RJL rotary joint offered by Kuroda Industry Co., Ltd.

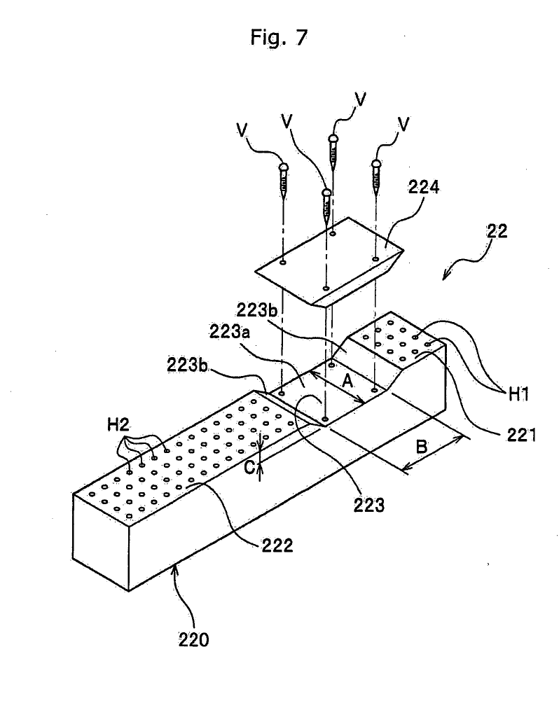

Referring to FIG. 7 showing the tape carrier 22 in detail, the tape carrier 22, which comprises an elongated parallelpiped suction table 220 disposed at a horizontal distance from where the empty tape reel 1 is located when the empty tape reel 1 is set in position in the tape reel setting device 21 and has a function of sucking and grasping an end portion of magnetic tape strip MT1 and carrying it to the reel hub 2 of the empty tape reel 1, is movable into a space between the upper and lower flanges 4 and 3 near the reel hub 2 of the tape reel 1. Generally, the suction table 220 forming the tape carrier 22 comprises a first suction table section 221, a sponge seat 223 and a second suction table section 222 in order from the front (on a side of tape reel setting device 21). These first and second suction table sections 221 and 222 are on the same level and separate from each other in a longitudinal direction by the sponge seat 223 formed in the shape of dent and serve as tape grasping means. The sponge seat 226 is formed in the shape of dent by a bottom wall 223a and front and rear tapered walls 223b continuing to the first and second suction table sections 221 and 222, respectively. The first suction table section 221 has a number of air orifices H1 in communication with a common air passage (not shown) formed in the suction table 220 which is connected to and disconnected from an eternal air compressor and a vacuum pump (not shown) through a conduit tube having a selector solenoid valve. Therefore, the first suction table section 221 can suck and grasp the magnetic tape strip MT with vacuum thereon. Similarly, the second suction table section 222 has a number of air orifices H2 in communication with a common air passage (not shown) formed in the suction table 220 which is connected to and disconnected from a vacuum pump (not shown) through a conduit tube having a solenoid valve. Therefore, the second suction table section 222 can suck and grasp the magnetic tape strip MT with vacuum thereon. In the case of a tape width of ½inch (12.65 mm), the sponge seat 223 is cut to a width A less than 11 mm, a length B greater than 19 mm and a depth C greater than 0.5 mm. In order to avoid interference of the tape carrier 22 with the flanges 3 and 4 of tape reels 1, the sponge seat 223 should have a width A less than the magnetic tape strip MT. Further, the sponge seat 223 having at least a width less than 11 mm and a length B greater than 19 mm prevents the front and rear tapered walls 223b from interfering with the reel hub 2 when the bottom wall 223a is brought into contact with the reel hub 2.

A sponge pad 224, that is tapered so as to fit the front and rear red walls 223b, is attached to the sponge seat 223 by set screws V, or otherwise may be secured by an adhesive or a double-sides adhesive tape. The sponge pad 224 is brought into crimping on the reel hub 2 of the tape reel 1 to force the magnetic tape strip MT against the reel hub 2 of the tape reel 1 along a shape of the reel hub 2 when the tape carrier 22 is moved upward.

In operation of the tape winding apparatus 100, as shown in FIG. 4, while the tape feeder 30 is activated to feed a magnetic tape strip MT from one of the tape reels R1 and R2, the reel feeder 70 feeds an empty tape reel 1 into the reel setting device 21. The empty tape reel 1 is set in the reel setting device 21 so as to permit the tape reel 1 to rotate. The magnetic tape strip MT travels in its given traveling path defined by a number of guide rollers G to the tape end attaching apparatus 20, passing through the polishing device 40, the cleaning devices 50 and the tension control device 60. When an end portion of magnetic tape strip MT1 reaches the tape end attaching apparatus 20, the vacuum pump is activated so that the tape carrier 22 sucks and grasps the end portion of magnetic tape strip MT1, and then the tape end attaching apparatus 20 attaches the end portion of magnetic tape strip MT1 to the reel hub 2 of the tape reel 1 set in the reel setting device 21.

As shown in FIG. 6A, the tape reel 1 fed from the reel feeder 70 and set in the reel setting device 21 is, on one hand, coupled for rotation to the tape reel driving device 211 of the tape reel setting device 21 through engagement between the driven face gear 5 of the tape reel 2 and the driving face gear 212a of the tape reel driving device 211 and, on the other hand, engaged by the positioning head 211c through the sealing ring 211e. Since the positioning head 211c is supported for rotation on the shat 211b through the ball bearing 211d, the tape reel 1 engaged by the positioning head 211c is rotatable with respect to the shaft 211b. Further, the center bore 2a of the reel hub 2 is air-tightly closed by the positioning head 211c engaging the center opening 4b of the upper flange 4 of the tape reel 1 and the sealing ring 211e pressed against the upper flange 4 of the tape reel 1 and by the driving face gear 212a of the tape reel driving device 211 engaging with the driven face gear 5 of the lower flange 3 of the tape reel 1. In order to provide complete air-tightness of the center bore 2a of the reel hub 2, it is preferred to clad the driving face gear 212a with an elastic material such as rubber, or otherwise to provide an annular searing member surrounding the interface between these face gears 5 and 212a. The center bore 2a of the reel hub 2 is in communicating with the air passage 212c extending through the driving face gear 212a and the rotary shaft 212b of the motor 212d. Since the air passage 212c is connected to the vacuum pump 212g through the air passage 216a and the annular groove 216d of the rotor 216 of the rotary joint unit 212e, the air passage 215a of the stator 215 of the rotary joint unit 212e and the suction pipe 212f the interior of the center bore 2a of the reel hub 2 is depressurized to suck in ambient air through the permeable pores of the reel hub 2. That is, the reel setting device 21 holds the tape reel 1 so as to draw the reel hub 2 inward. Therefore, when coming close to the reel hub 2, the end portion of magnetic tape strip MT1 is sucked and grasped by the reel hub 2 with vacuum pressure. Further, the rotary joint unit 212e holds intercommunication of air between the center bore 2a of the reel hub 2 and the vacuum pump 212g despite of rotation of the rotor 216, so that the interior of the center bore 2a of the reel hub 2 is always depressurized during rotation of the tape reel 1 by the motor 212d.

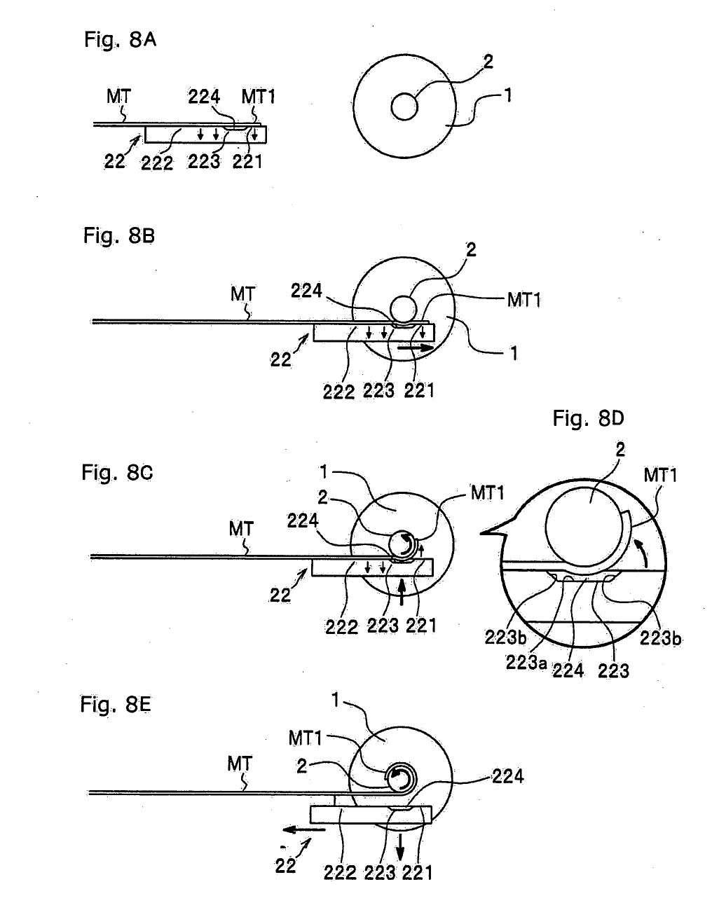

FIGS. 8A through 8E show a process of tape end attaching. As shown in FIG. 8A, an end portion of the magnetic tape strip MT1 is sucked and grasped by the tape carrier 22, more specifically the suction table 220, with vacuum. Then, as shown in FIG. 8B, the ape carrier 22 is moved horizontally until the sponge pad 223 is positioned below the reel hub 2 and, at the same time, the vacuum pump 212g is activated to continuously depressurize the interior of the center bore 2a of the reel hub 2. Thereafter, as shown in FIG. 8C, the vacuum pump associated with the first suction table section 221 is deactivated so that the first suction table section 221 release partly the end portion of the magnetic tape strip MT1 and, at the same time, the compressor associated with the first suction table section 221 is activated to supply pressurized air through the air orifices H1 so as thereby to blow up the end portion of magnetic tape strip MT released from the first suction table section 221. In consequence, as shown in detail in FIG. 8D, the end portion of the magnetic tape strip MT1 is firmly sucked and grasped by the reel hub 2. As shown in FIG. 8E, the vacuum pump associated with the second suction table section 222 is deactivated so that the second suction table section 222 releases the remaining end portion of the magnetic tape strip MT1, and the tape carrier 22 is lifted down and horizontally moved back. At the same time, the motor 212d of the reel driving unit 212 is activated to rotate the tape reel 1 through a predetermined angle of rotation so as to wind an end portion of the magnetic tape strip MT1 on the reel hub 2. In this way, the tape end attaching process is completed. In this instance, since, when the vacuum pump 212g is deactivated, the reel hub 2 is apt to loosen the end portion of magnetic tape strip MT1, it is preferred to deactivate the vacuum pump 212g after making more than one convolutions, more preferably several convolutions, of the end portion of the magnetic tape strip MT1 on the reel hub 2.

After attaching the end portion of magnetic tape strip MT1 to the reel hub 2, the tape reel 1 is rotated at a high and varying rotational speed by the motor 212g to wind the magnetic tape strip MT on the tape reel 1. Specifically, the tape reel 1 is rotated at a speed which is gradually increased at the beginning of tape winding, maintained at a predetermined speed for a predetermined period of time after reaching it and, subsequently, gradually decreased on the basis of prediction of a necessary time for completion of tape winding of a given length of magnetic tape strip MT so that the tape reel 1 stops at the completion of tape winding.

When completing winding of a given length of magnetic tape strip MT, the magnetic tape strip MT wound on the tape reel 1 is cut off by a cutting device (not shown). Thereafter, a leader tape strip L (see FIG. 3) is connected to a cut end of the magnetic tape strip MT wound on the tape reel 1 by a splicing device (not shown), and a leader pin 5 is attached to the free end of the leader tape strip L (see FIG. 3). These splicing and pin-attaching may be automatically performed by an automatic device which is known in various forms and may take any form well known in the art. In this way, the tape end attaching process is completed. The tape reel 1 with the magnetic tape strip 1 wound thereon is released and ejected from the reel driving unit 212 and is transported to a tape cartridge assembling line where the tape reel 1 is installed into the cartridge case 11 so as thereby to complete a magnetic tape cartridge 10 shown in FIG. 3.

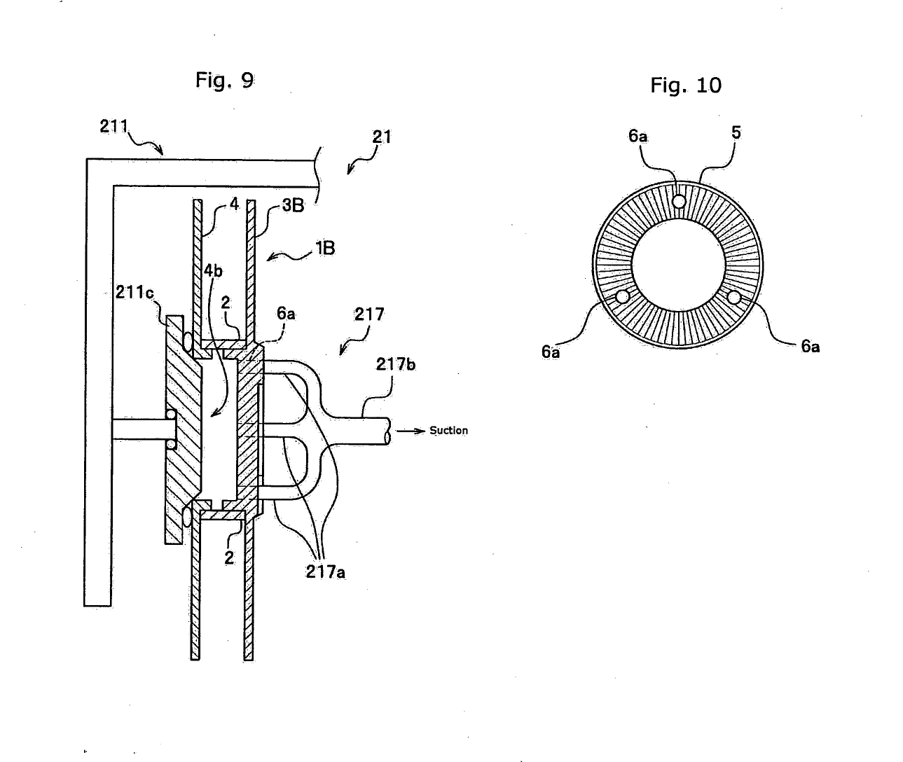

FIG. 9 shows a reel setting device 21B for receiving an empty tape reel 1B and setting it for rotation according to another embodiment of the present invention. The tape reel 1B is identical with the tape reel 1 shown in FIG. 1 except that a lower flange 3B has three through-bores 6a in place of a center opening. Specifically, as shown in FIG. 9A, the tape reel 1B comprises a cylindrical hollow core formed as a reel hub 2 made of a porous material and upper or first and lower or second disk-shaped flanges 4 and 3B which are identical in outer diameter. The reel hub 2 has a number of pores distributed allover the hub wall through which the interior and the exterior of the center bore 2a of the reel hub 2 are in air intercommunication with each other. The lower flange 3B has a circular boss 3a which extends from the inner surface of the lower flange 3B so as to fit tightly in one of opposite end openings of the reel hub 2 and is provided with a driven face gear 5B formed on an outer surface thereof. As shown in FIG. 10, the driven face gear 5B has three through-bores 6a arranged at regular angular intervals therein in place of a center opening of the tape reel 1 shown in FIG. 1.

The reel setting device 21B is similar to the reel setting device 21 shown in FIGS. 6A and 6B except that the rotary shaft 212b of the reel setting device 21 is replaced by a coupling shaft 217 comprising a rotary shaft portion 217b serving as both rotary shaft and air pipe and a three-arm coupling head 217a serving as both coupler and air pips which are formed as an integral component. The coupling shaft 217 couples the tape reel 1B to the motor shaft through engagement between three arms of the three-arm coupling head 217a and the three through-bores 6a of the driven face gear 5B of the lower flange 3B, respectively.

According to the reel setting device 21B, the tape reel 1B is supported between the positioning head 211c and the three-arm coupling head 217a of the tape reel driving device 211. As a result, since, while the tape reel 1B is supported for rotation, the center bore 2a of the reel hub 2 of the tape reel 1B is communicated with the vacuum pump 212g through the coupling shaft 217 and the rotary joint unit 212e (see FIGS. 6A and 6B), an end portion of magnetic tape strip is sucked by and attached to the reel hub 2 of the tape reel 1B.

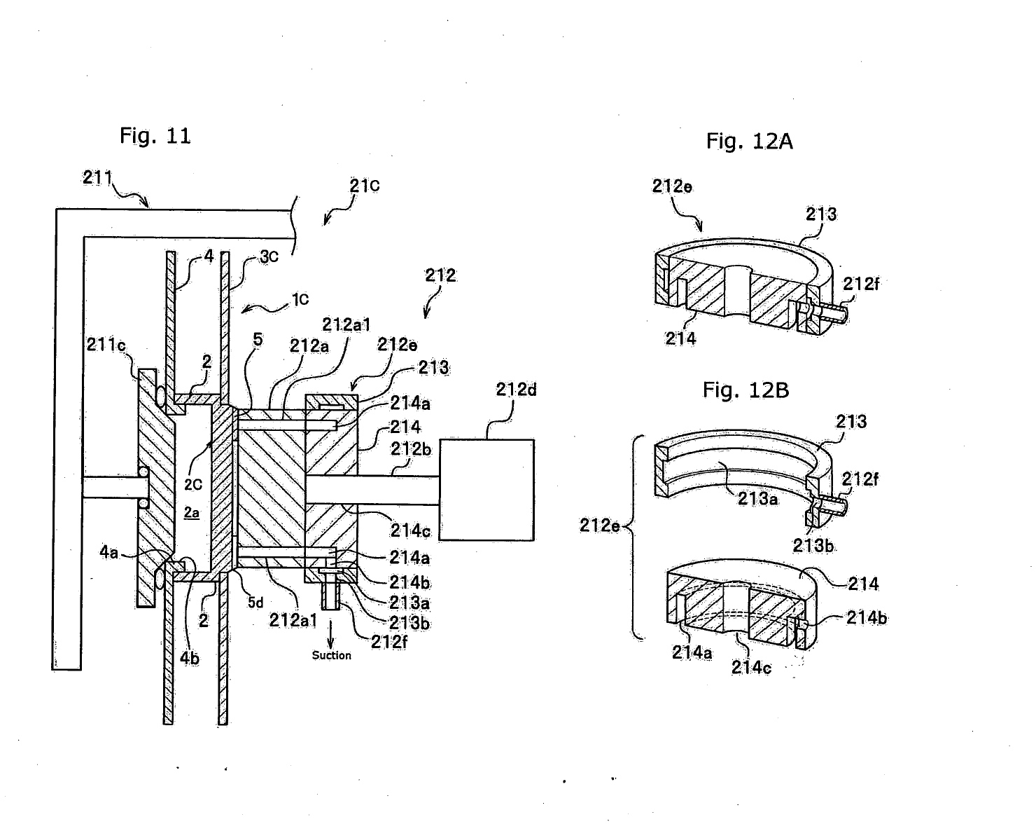

FIGS. 11, 12A and 12B show a reel setting device 21C for receiving an empty tape reel 1C and setting it for rotation according to still another embodiment of the present invention. The tape reel 1C is comprises an upper flange 4 just the same as that of the previous embodiment shown in FIG. 1, a lower flange 3C having a center opening 3c and a reel hub component 2C comprising a reel hub portion 2 having a center 2a formed axially therein and a driven face gear portion 5 having a shoulder 5b at one end of the reel hub 2 which are formed as one integral piece. The reel hub component 2C including the reel hub 2 and the driven face gear 5 is made of a porous material. The tape reel 1C is assembled by fitting a boss 4a of the upper flange 4 in an axial end opening of the center bore 2a of the reel hub 2 and mounting the lower flange 3C on the shoulder 5b of the driven face gear 5 and then bonding them with an adhesive, or otherwise by ultrasonic bonding if both components are made of resins.

The reel driving unit 212 comprises a motor 212d having a rotary shaft 212b, a reel driving head having a face gear (driving face gear) 212a connected to and end of the rotary shaft 212b and engageable with the driven face gear 5 of the lower flange 4 of the tape reel 1, and a rotary joint unit 212e fixedly mounted on the reel driving head 212a. The drive face gear 212a has an annular air channel 212a1 formed as an air passage axially therein. As shown in FIGS. 12A and 12B in detail, the rotary joint unit 212e, which has a cylindrical shape, comprises a cylindrical hollow stator 213 and a rotor 214 air-tightly received for rotation in the stator 213. The stator 213 has an air passage comprising an annular groove 213a formed in an inner wall thereof and a port 213b extending from the annular groove 213a and opening to the exterior of the stator 213. A suction pipe 212f extending to the vacuum pump 212g (see FIG. 6A) is connected to the port 213b. The rotor 214 has a center bore 214c formed axially therein in which the rotary shaft 212b of the motor 212d is tightly fitted. Further, the rotor 214 has an air passage comprising an open ended annular groove 214a formed coaxially with the center bore 213c therein and a port 214b extending from the annular groove 214a and opening to the annular groove 213a of the stator 213. The annular groove 214a of the rotor 214 is coaxial with and equal in diameter to the annular channel 212a1 of the driving face gear 212a. By way of the air passage arrangement, the annular air channel 212a1 is always intercommunicated with the vacuum pump 212 g through the suction pipe 212f despite of rotation of the rotor 214 by the motor 212d.

According to the reel setting device 21C, the tape reel 1C is engaged by and between the positioning head 211c and the driving face gear 212a so that the tape reel 1C is rotatable and the center bore 2a is air-tightly closed at the axial end thereof. When the vacuum pump 212g is activated, the interior of the center bore 2a of the reel hub 2 is continuously depressurized through the air channel 212a1 of the driving face gear 212a, the annular groove 213a and 214a of the rotary joint unit 212e and the suction pipe 212f In consequence, since the reel hub component 2C is made of a porous material, the center bore 2a of the reel hub 2 is depressurized to suck in ambient air through pores of the reel hub 2 and then, the end portion of magnetic tape strip MT1 is sucked and grasped by the reel hub 2 with vacuum pressure.

As just described above, the tape cartridge manufacturing method prevents an occurrence of a radial winding irregularity in a roll of magnetic tape strip wound onto a tape reel and, as a result, enables to produce magnetic tape cartridges at a high yield rate.

Although, in the above embodiment the tape reels described above are made up of two or three components, they may be provided with other functional components. The present invention is suitable for a single reel type magnetic tape cartridge and herein described in this context. However, it should be appreciated that the invention has broader application and is not limited to this particular type. Further, it is also to be understood that although the present invention has been described with regard to preferred embodiments thereof, various other embodiments and variants may occur to those skilled in the art, which are within the scope and spirit of the invention, and such other embodiments and variants are intended to be covered by the following claims.

What is claimed is:

1. A tape reel on which a pate strip is to be wound, said tape reel comprising:
a reel hub having a center bore formed axially therein;
a first flange connected to one of opposite ends of said reel hub; and
a second flange connected to the other of said opposite ends of said reel hub in parallel with said first flange;
wherein said reel hub has pores for air intercommunication between the interior and the exterior of said center bore of said reel hub.

2. The tape reel as defined in claim 1, wherein said reel hub is made of a porous material.

3. A tape cartridge comprising:
a tape reel on which a pate strip is to be wound;
a cartridge case for enclosing said tape reel; and
a tape strip wound on said tape reel;
wherein said tape reel comprising:
a reel hub having a center bore formed axially therein on which said tape strip is wound and pores for air communication between the interior and the exterior of said center bore of said reel hub;
a first flange connected to one of opposite ends of said reel hub;
a second flanges connected to the other of said opposite ends of said reel hub in parallel with said first flange.

4. The tape cartridge as defined in claim 3, wherein said reel hub is made of a porous material.

5. A method of attaching an end portion of a tape strip to a reel hub of a tape reel on which a tape strip is wound and is provided with flanges connected to opposite ends of said reel hub before winding said tape strip on said tape reel, said reel hub having a center bore formed axially therein and pores for air communication between the interior and the exterior of said center bore of said reel hub, said tape end attaching method comprising the steps of:
setting said tape reel into a state where said tape reel is rotatable and said center bore of said reel hub is closed at axial ends thereof;
grasping said end portion of said tape strip by a tape carrier movable in close proximity to and away from said tape reel;
moving said tape carrier grasping said end portion of said tape strip until said end portion of said tape strip is placed adjacently to said reel hub; and
depressurizing the interior of said center bore of said reel hub so as thereby to attach said end portion of tape strip to said reel hub with air sucked in through said pores.

6. A method of manufacturing a tape cartridge including a tape reel which comprises a reel hub having a center bore formed axially therein and pores for air communication between the interior and the exterior of said center bore of said reel hub and a first and a second flange connected to opposite ends of said reel hub, respectively, in parallel with each other; a cartridge case for enclosing said tape reel; and a tape strip wound on said tape reel; said tape cartridge manufacturing method comprising the steps of:
setting said tape reel into a state where said tape reel is rotatable and said center bore of said reel hub is closed at axial ends thereof;
gasping said end portion of said tape strip by a tape carrier movable in close proximity to and away from said tape reel;
moving said tape carrier grasping said end portion of said tape strip until said end portion of said tape strip is placed adjacently to said reel hub;
depressurizing the interior of said center bore of said reel hub so as thereby to attach said end portion of tape strip to said reel hub with air sucked in through said pores; and
rotating said tape reel to wind said tape strip on said tape reel.
